(19) United States
(12) Patent Application Publication
(10) Pub. No.: US 2008/0022920 A1
(43) Pub. Date: Jan. 31, 2008

(54) Energy transducer module and light apparatus

(75) Inventor: Udo Custodis, Wanchai (HK)

Correspondence Address: COHEN PONTANI LIEBERMAN & PAVANE LLP, Suite 1210, 551 Fifth Avenue, New York, NY, 10176, US

(73) Assignee: Patent-Treuhand-Gesellschaft fur elektrische Gluhlampen mbH, Munchen (DE)

(21) Appl. No.: 11/827,047

(22) Filed: Jul. 10, 2007

(30) Foreign Application Priority Data
Jul. 10, 2006 (DE) 10 2006 032 007.7

(51) Int. Cl. F21L 13/02; G01F 1/10; G01F 15/06; G01K 13/02

(52) U.S. Cl. 116/202; 362/191; 362/192; 374/100; 73/861.89

(57) ABSTRACT

An energy transducer module (1) which has a turbine (2) for converting the flow energy of a fluid (4) to rotation energy, and has a generator (3) for converting the rotation energy to electrical energy, with the energy transducer module (1) being provided as an energy source for a unit which produces radiation. The energy transducer module (1) can alternatively be used as a flow sensor.

### RELATED APPLICATION

This patent application claims the priority of the German patent application no. 10 2006 032 007.7 filed Jul. 10, 2006, the disclosure content of which is hereby incorporated by reference.

### FIELD OF THE INVENTION

The invention relates to an energy transducer module and to a light apparatus which has an energy transducer module.

### BACKGROUND OF THE INVENTION

An energy transducer can be used to convert a first energy form to a second energy form. For example, a rechargeable battery can be used to convert chemical energy to electrical energy. In contrast, a dynamo can be used to convert kinetic energy to electrical energy. The electrical energy can be used, inter alia, for operating a light source.

Utility model DE 20 2005 003 216 U1 discloses a glove blinker for cyclists, roller-blade skaters and roller skaters with a light indication composed of light-emitting diodes, by which means a direction change can be indicated in road traffic when visibility is poor and when it is dark.

### SUMMARY OF THE INVENTION

One object of the present invention is to provide an energy transducer module which allows a simple operation of a unit which produces radiation.

A further object of the present invention is to provide. a light apparatus which can be operated easily.

These and other object are attained in accordance with one aspect of the invention directed to an energy transducer module comprising a turbine for converting the flow energy of a fluid to rotational energy, and a generator for converting the rotational energy to electrical energy, with the energy transducer module being adapted to be an energy source for a unit which produces radiation.

By way of example, the turbine may be in the form of an impeller or turbine blade wheel, which is caused to rotate by the fluid striking the impellers or blades. The rotary movement of the turbine is transmitted by means of a mechanical shaft to a rotor which is located inside the generator. The rotor rotates in a stator. A magnetic field which is produced artificially by the stator induces an electrical voltage, which can be tapped off, in electrical conductors or conductor windings of the rotor. The electrical energy or power produced in this way is dependent on the amount of rotational energy introduced, preferably being proportional to the rotational energy or mechanical energy or the mechanical power that is introduced.

In one alternative embodiment, the energy transducer module is used as a flow sensor. The fluid flow can advantageously be determined by means of the electrical energy that is produced, or of an output voltage from the energy transducer module, which is dependent on the rotational energy that is introduced and is thus dependent on the fluid flow. The electrical energy is preferably proportional to the rotational energy, and is thus proportional to the fluid flow. The fluid flow corresponds to the amount of fluid which flows through a specific cross-section per unit time. The fluid flow can be determined by the density of the fluid, the flow rate and the cross-sectional area.

According to one preferred embodiment, the energy transducer module is intended for the low-energy range. The low-energy range extends particularly preferably between 0 W and 100 W with discrepancies of 10% being tolerable. This energy range is advantageously suitable for operating a unit which produces radiation and, for example, comprises a plurality of light-emitting diodes. The turbine is preferably a miniature turbine, and the generator is preferably a miniature generator. The turbine which operates in the low-energy range may be referred to as a miniature turbine. In a corresponding manner, the generator which operates in the low-energy range can be referred to as a miniature generator. In this case, the dimensions of the generator are preferably in the single-digit or two-digit millimeter range. For example, the diameter of the generator may be about 6 mm, and the length may be about 15 mm.

According to a further preferred embodiment, the fluid is a liquid. However, a gas can also be used as the fluid. By way of an example, the liquid may be water and the gas may be air. The energy transducer module is advantageously suitable for applications relating to the supply of water in private households, for example as an attachment, in particular as a screwed-on attachment to a faucet or as an insert in a waterpipe. Further fields of application relate to the heating and air-conditioning of rooms.

The fluid preferably flows through a channel. In particular, the channel may be in the form of a tunnel. The energy transducer module is arranged in the channel or at the end of the channel such that the fluid flows through the turbine, and drives it. There are various possible ways to arrange the energy transducer module relative to the channel. According to a first option, the energy transducer module is provided as an attachment to one end of the channel. According to a second option, the energy transducer module can be inserted into the channel such that it is surrounded by the channel. According to a third option, the energy transducer module is provided as an adaptor between two channel sections. The cross-sectional area of the channel corresponds to the cross-sectional area as mentioned above which is required to determine the fluid flow.

In particular, the channel may be a pipe or a hose. If water is used as the fluid, then the channel may be a water pipe or water hose. Both water and electrical energy can advantageously be taken from a water pipe or water hose provided with the energy transducer module according to the invention. The unit which produces radiation can advantageously be supplied with this electrical energy.

The unit which produces radiation emits radiation when the turbine is driven by means of the fluid. The radiation intensity is in this case preferably proportional to the fluid flow.

According to a further preferred variant, the unit which produces radiation comprises at least one semiconductor component which produces radiation. For example, the semiconductor component which produces radiation may be a light-emitting diode. In particular the semiconductor component which produces radiation or the unit which produces radiation is intended to emit the radiation that is produced directly to the environment. In particular, this means that the component which produces radiation or the unit which produces radiation is not followed by an indication element, for example a display, in the emission direction. However, it is possible for the component which produces radiation or the unit which produces radiation to be followed by an element with an optical effect, for example a lens or a reflector, in the emission direction.

A light apparatus according to the invention has an energy transducer module as described above and a unit which produces radiation. The light apparatus advantageously requires no additional power supply, in the form of a battery, a rechargeable battery or a connection to an electrical power supply system for operation. In particular, the light apparatus is advantageously used in a closed system in which a fluid is already present. The light apparatus can then be operated autonomously, that is to say the light apparatus can be operated solely by means of the energy in the closed system, specifically the flow energy of the fluid.

For power supply purposes, the energy transducer module is electrically connected to the unit which produces radiation. Furthermore, the unit which produces radiation can be mechanically connected to the energy transducer module. In particular, the light apparatus may comprise a housing to which the unit which produces radiation is attached and in which the energy transducer module is arranged. The unit which produces radiation and, for example, has a plurality of semiconductor components is preferably arranged such that the semiconductor components circumferentially surround the energy transducer module.

The spectral intensity maximum of the unit which produces radiation is preferably in the ultraviolet, visible or infrared band, in particular between 300 nm and 800 nm.

According to one preferred embodiment, the light apparatus is provided for illumination. The light apparatus can be used for illuminating the fluid, the channel or the immediately surrounding area.

According to a further preferred embodiment, the light apparatus is provided as a flow indication. This is because the radiation intensity depends on the electrical energy supplied to the unit which produces radiation, and this is in turn governed by the fluid flow. In this case, the greater the radiation intensity, the greater is the fluid flow. The unit which produces radiation can emit light more brightly the greater the fluid flow is. Alternatively, the electric current supplied to the unit which produces radiation can be kept constant, and the radiation intensity can therefore also be kept constant.

Furthermore, the light apparatus may be intended to indicate the temperature of the fluid. The light apparatus for this purpose expediently has a temperature sensor for determining the temperature of the fluid.

The light apparatus preferably has a first subunit which produces radiation and a second subunit which produces radiation in order to indicate the temperature, with each subunit comprising at least one component which produces radiation. In particular, the first subunit emits radiation when the temperature of the fluid is in a first temperature range, while the second subunit emits radiation when the temperature of the fluid is in a second temperature range. The information about the temperature of the fluid can therefore advantageously be visualized in a simple form.

The first and the second temperature range overlap preferably at most partially. It is therefore advantageously possible to distinguish between three states; “cold”, “medium”, “hot”. For example, the first temperature range may extend up to a temperature <30° C., while the second temperature range starts at a temperature >18° C. In particular, only the first subunit illuminates at a temperature <18° C., while only the second subunit illuminates at a temperature >30° C., with both subunits illuminating at a temperature between 18° C. and 30° C.

In one preferred variant, the first subunit emits radiation at a first wavelength, and the second subunit emits radiation at a second wavelength. By way of example, the first subunit may emit blue light, and the second subunit may emit red light.

In a further preferred variant, the unit which produces radiation is arranged such that the fluid is illuminated. In particular, the fluid can flow around the unit which produces radiation. In this case, the unit which produces radiation may be located internally relative to the channel.

Alternatively, the light apparatus may be located externally relative to the channel, and may emit the radiation that is produced into the immediately surrounding area.

The unit which produces radiation preferably comprises at least one light-emitting diode. A suitable light-emitting diode is disclosed, for example, in Laid-Open Specification DE 10241989, the content of which is hereby incorporated by reference.

The light apparatus can be designed such that it can be plugged on to a fluid inlet, fluid outlet or fluid passage opening of the channel. The light apparatus may have an attachment apparatus, for example, a thread for attachment purposes.

### BRIEF DESCRIPTION OF THE DRAWINGS

FIG. 1 shows a schematic sectional view of a first exemplary embodiment of an energy transducer module according to the invention,

FIG. 2 shows a schematic sectional view of a second exemplary embodiment of an energy transducer module according to the invention,

FIGS. 3A and 3B respectively show a schematic sectional view and side view of a first exemplary embodiment of a light apparatus according to the invention,

FIGS. 4A and 4B show a schematic sectional view and side view of a second exemplary embodiment of a light apparatus according to the invention, and

FIG. 5 shows a schematic perspective view of a generator of a size in the same order of magnitude of that provided for the purposes of the invention.

### DETAILED DESCRIPTION OF THE DRAWINGS

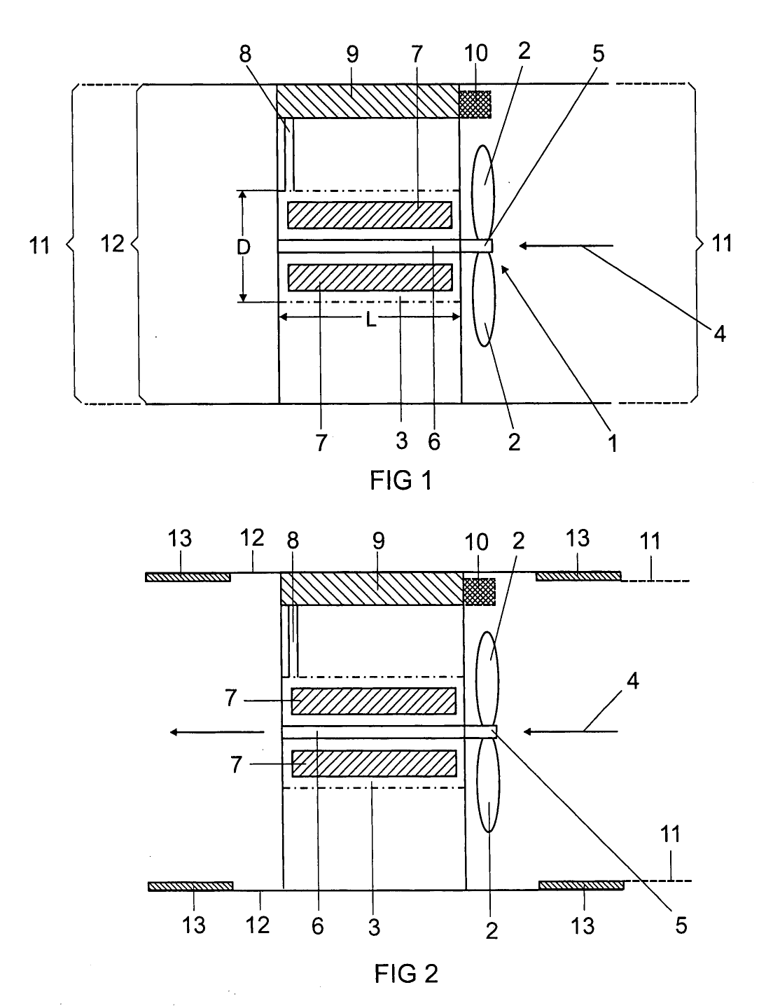

The energy transducer module 1 illustrated in FIG. 1 comprises a turbine 2 and a generator 3. The flow energy of a fluid 4 is converted to rotational energy by means of the turbine 2. Furthermore, the rotational energy is converted to electrical energy by means of the generator 3. The electrical energy can be tapped off from the generator 3, and can be lead to a circuit unit 9 by means of an electrical connection 8. A unit which produces radiation (not illustrated) can be actuated by means of the circuit unit 9. Furthermore, an electrical outlet signal which is proportional to the fluid flow can be produced by means of the circuit unit 9, so that the energy transducer module 1 is used as a flow sensor. The circuit unit 9 may also be electrically connected to a temperature sensor 10 for determining the temperature of the fluid 4.

The turbine 2 is preferably in the form of an impeller which is driven by means of the fluid 4. The rotary movement of the turbine 2 is transmitted by means of a mechanical shaft 5 to a rotor 6 which is located in the interior of the generator 3. The rotor 6 rotates in a stator 7. Appropriate dimensions for the generator 3, are in the single-digit or two-digit millimeter range. By way of example, the diameter may be D=6 mm, and length L=15 mm. The voltage produced by means of the generator 3 preferably corresponds to a voltage of 12 V, which is equal to the voltage delivered by a conventional battery.

The energy transducer module 1 is arranged in a channel-like housing 12 (solid lines) which merges into a channel 11 (dashed lines).

As illustrated in FIG. 2, the housing 12 has an attachment apparatus 13 at the end, by means of which it can be fixed together with the energy transducer module 1 to the channel 11. The housing 12 may be plugged onto the channel 11 as an end piece or may be integrated in the channel 11 as an adaptor. The energy transducer module 1 is preferably also firmly connected to the housing 12, and is circumferentially surrounded by it.

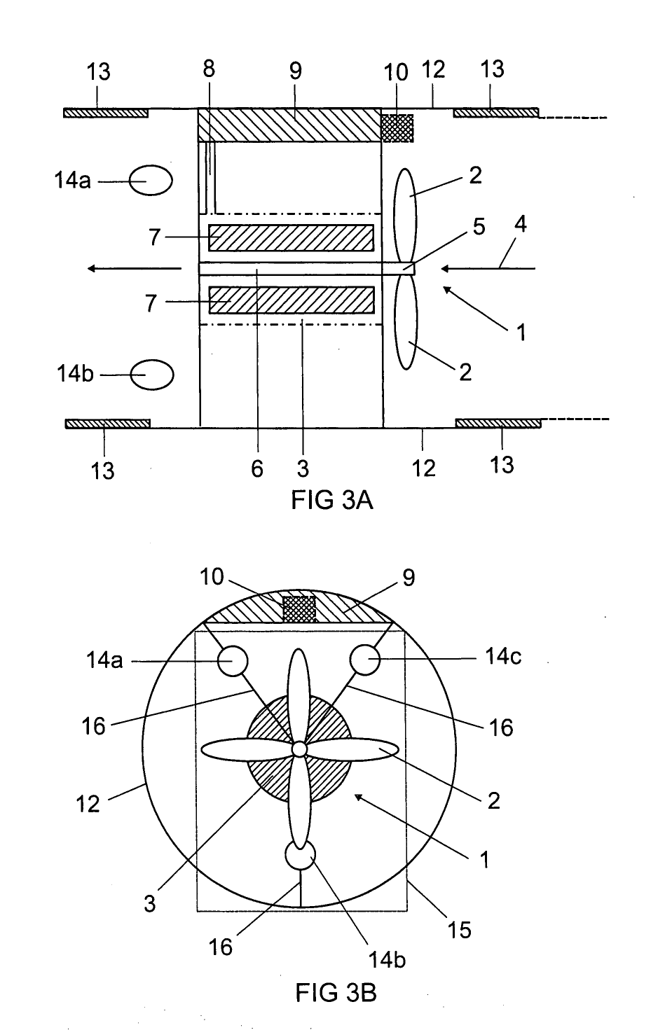

FIGS. 3A and 3B show the energy transducer module 1 and a unit which produces radiation, and, together, these form a light apparatus 15. The unit which produces radiation comprises a plurality of components 14a to 14c which produce radiation. The components 14a to 14c which produce radiation are arranged within the housing 12, so that it is possible to illuminate the fluid 4. The components 14a to 14c which produce radiation are preferably attached to the housing 12 by means of transverse struts 16 which run radially relative to the energy transducer module 1. For power supply purposes, the components 14a to 14c which produce radiation and, in particular, are light-emitting diodes, are electrically connected to the circuit unit 9, or to the energy transducer module 1 if there is no circuit unit 9. The unit which produces radiation is supplied with power by means of the energy transducer module 1, with the turbine 2 preferably being driven by means of a liquid, for example water, or by means of a gas, for example air.

The housing 12 can be fixed by means of the attachment apparatus 13 to a fluid inlet, fluid outlet or fluid passage opening of the channel 11 (see FIG. 1). By way of example, the channel 11 may be a faucet, onto whose outlet opening the light apparatus 15 is plugged.

The fluid temperature or water temperature can be determined by means of the temperature sensor 10. If the water temperature is below 18° C., then, for example, only the component 14a emits radiation. By way of example, the component 14a may emit blue light. Furthermore, only the component 14b can emit radiation when the water temperature is higher than 30° C., with the component 14b then, for example, emitting red light. If the water temperature is between 18° C. and 30° C., the two components 14a and 14b may, for example, emit radiation. Alternatively, only the component 14c could illuminate, for example, green, between 18° C. and 30° C.

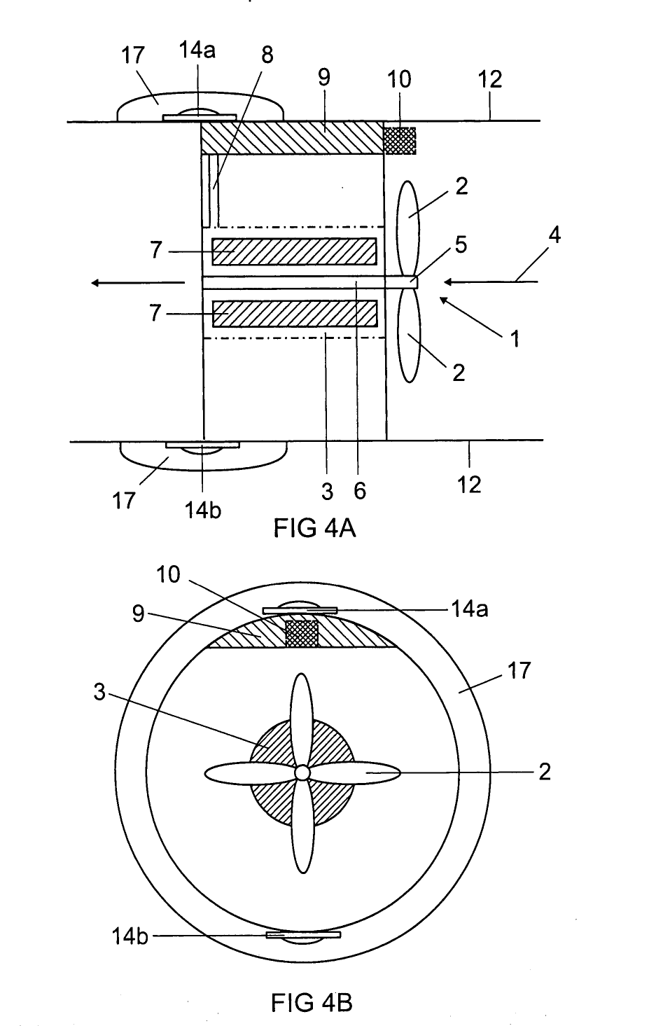

The components 14a and 14b which are illustrated in FIGS. 4a and 4b and produce radiation are arranged outside the housing 12, so that they can emit radiation to the surrounding area during operation. In order to allow a uniform radiation distribution, the components 14a and 14b may be surrounded by a diffusor 17. The diffusor 17 preferably contains a transparent material, in particular a plastic material or glass, and is in the form of a ring surrounding the housing 12. The components 14a and 14b are preferably attached to the housing 12.

It is feasible for the light apparatus formed from the energy transducer module 1 and the unit which produces radiation to be plugged onto a garden hose. During operation, the components 14a and 14b illuminate, so that plants can advantageously be sprayed even when the light level is poor.

Furthermore, as already mentioned above, conclusions about the fluid flow or the water flow can be drawn from the radiation intensity, with the radiation intensity increasing as the fluid flow becomes stronger. The light apparatus can therefore be used as a flow indication. A light apparatus such as this may, for example, be fitted in a washing machine or a dishwasher in order to monitor the water flow. Furthermore a light apparatus such as this may be used to monitor the air flow in air-conditioning installations.

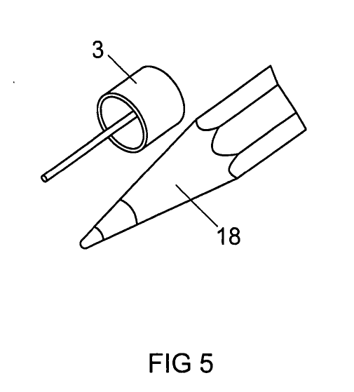

FIG. 5 is intended to illustrate the size relationships of a generator 3 according to the invention. As can be seen, the order of magnitude of the size of the generator 3 corresponds to that of a conventional pencil point 18.

The invention is not restricted by the description based on the exemplary embodiments. In fact, the invention covers any new feature and any combination of features, in particular including any combination of the features in the patent claims, even if this feature or this combination is not itself explicitly stated in the patent claims or exemplary embodiments.

I claim:

1. An energy transducer module comprising:
a turbine for converting the flow energy of a fluid to rotational energy; and
a generator for converting the rotational energy to electrical energy;
wherein the energy transducer module is adapted to be an energy source for a unit which produces radiation.

2. The energy transducer module as claimed in claim 1, adapted for a low-energy range, which extends between 0 W and 100 W.

3. The energy transducer module as claimed in claim 2, with the turbine being a miniature turbine, and with the generator being a miniature generator.

4. The energy transducer module as claimed in claim 1, with the fluid being a liquid or gas.

5. The energy transducer module as claimed in claim 1, which is integrated in a channel or is arranged at the end of a channel through which the fluid flows.

6. The energy transducer module as claimed in claim 5, with the channel being a water pipe or water hose.

7. The energy transducer module as claimed in claim 1, with the radiation intensity being proportional to the fluid flow.

8. The energy transducer module as claimed in claim 1, with the unit which produces radiation comprising at least one semiconductor component which produces radiation.

9. A light apparatus which has an energy transducer module as claimed in claim 1, and a unit which produces radiation.

10. The light apparatus as claimed in claim 9, with the unit which produces radiation being mechanically connected to the energy transducer module.

11. The light apparatus as claimed in claim 10, which comprises a housing to which the unit which emits radiation is attached and in which the energy transducer module is arranged.

12. The light apparatus as claimed in claim 9, which is provided for illumination.

13. The light apparatus as claimed in claim 9, with the radiation intensity being proportional to the fluid flow, wherein the light apparatus is adapted to provide a flow indication.

14. The light apparatus as claimed in claim 9, which is intended to indicate the temperature of the fluid.

15. The light apparatus as claimed in claim 14, which has a temperature sensor for determining the temperature of the fluid.

16. The light apparatus as claimed in claim 14, with a subunit which produces first radiation emitting radiation when the temperature of the flow is in a first temperature range, and with a subunit which produces second radiation emitting radiation when the temperature of the fluid is in a second temperature range.

17. The light apparatus as claimed in claim 16, with the temperature ranges at most partially overlapping.

18. The light apparatus as claimed in claim 16, with the first subunit emitting radiation at a first wavelength, and with the second subunit emitting radiation at a second wavelength.

19. The light apparatus as claimed in claim 9, with the unit which produces radiation being arranged such that the fluid is illuminated.

20. The light apparatus as claimed in claim 9, with the unit which produces radiation comprising at least one light-emitting diode.

21. The light apparatus as claimed in claim 9, which is integrated in a channel or is arranged at the end of a channel through which the fluid flows, wherein the light apparatus is adapted to be plugged on to a fluid inlet, fluid outlet or fluid passage opening of the channel.

22. A flow sensor comprising an energy transducer module which includes a turbine for converting the flow energy of a fluid to rotational energy, and a generator for converting the rotational energy to electrical energy.

23. The flow sensor as claimed in claim 22, adapted for a low-energy range, which extends between 0 W and 100 W.

24. The flow sensor as claimed in claim 23, with the turbine being a miniature turbine, and with the generator being a miniature generator.

25. The flow sensor as claimed in claim 22, which is integrated in a channel or is arranged at the end of a channel through which the fluid flows.

26. The flow sensor as claimed in claim 25, with the channel being a water pipe or water hose.

27. The flow sensor as claimed in claim 22, comprising means for determining the fluid flow with an output voltage at the energy transducer module, which output voltage is proportional to the fluid flow.
